(19) United States
(12) Patent Application Publication
(10) Pub. No.: US 2026/0343295 A1
(43) Pub. Date: Oct. 29, 2026

(54) EARLY FULL DUPLEX SUPPORT VIA INITIAL ACCESS ENHANCEMENT

(71) Applicant: QUALCOMM Incorporated, San Diego, CA (US)

(72) Inventors: Kiran Venugopal, Green Brook, NJ (US); Qian Zhang, Basking Ridge, NJ (US); Junyi Li, Greentown, PA (US)

(21) Appl. No.: 19/193,230

(22) Filed: Apr. 29, 2025

(51) Int. Cl. H04W 24/10; H04L 5/00; H04W 74/0833

(52) U.S. Cl. CPC H04W 24/10; H04L 5/0053; H04W 74/0833

(57) ABSTRACT

Techniques related to wireless communication are disclosed. Some aspects of the disclosure relate to a User Equipment (UE) comprising one or more processors configured to: receive one or more Synchronization Signal Blocks (SSBs) broadcast by a network entity; generate cross-link interference (CLI) measurement data using resources corresponding to the one or more SSBs; select, based on the CLI measurement data, an SSB beam from among a plurality of SSB beams; determine, based on the one or more SSBs, a Random-access Channel (RACH) occasion associated with the SSB beam, wherein a Physical RACH (PRACH) is mapped to the SSB beam; transmit, to the network entity via the PRACH, a random-access request at the RACH occasion; and receive, from the network entity via the SSB beam, a RACH response in response to the random-access request.

### TECHNICAL FIELD

The technology discussed below relates generally to wireless communication systems.

### BACKGROUND

Sub-band full duplex (SBFD) is a feature in certain 3^{rd} Generation Partnership Project (3GPP) wireless standards for enabling increased network spectrum efficiency. When SBFD is used, a User Equipment (UE) may transmit data on an uplink (UL) to a network entity, such as a gNodeB (gNB). The network entity may concurrently be transmitting data on a downlink (DL) to another UE. To enable SBFD, bandwidth is split into non-overlapping UL and DL sub-bands to enable simultaneous transmission and reception at a network entity (e.g., gNB) side. Devices may need to handle and mitigate cross-link interference (CLI) in order to fully achieve the full benefits of SBFD. CLI may occur when signals transmitted in the UL sub-band interfere with signals transmitted in the DL sub-band, or vice versa.

### SUMMARY

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. Unless expressly described, no one aspect or feature is essential to achieve technical effects or solutions discussed herein.

In order to achieve the full benefits of sub-band full duplex (SBFD), devices may need to handle and mitigate cross-link interference (CLI). Existing CLI measurement regimes and reporting formats are configured by a network (e.g., by a network entity) after a Radio Resource Control (RRC) connection is established with a UE. However, during initial access, when a UE tries to join a network, there may be contention with UEs that have already joined the network. Such contention may lead to CLI that corrupts communication between the UE and the network entity (e.g., a gNodeB, base station, disaggregated base station, etc.). Corruption of such communication may inhibit the ability of the UE to join the network.

This disclosure describes techniques that may address such issues. A network entity may broadcast different Synchronization Signal Blocks (SSBs) associated with different radio beams (e.g., SSB beams). When a UE joins a network, the UE receives one or more SSBs broadcast by the network entity. The UE may generate CLI measurement data using resources corresponding to the one or more SSBs. The UE may select, based on the CLI measurement data, an SSB beam from among a plurality of SSB beams. Additionally, the UE may determine, based on the one or more SSBs, a Random-Access Channel (RACH) occasion associated with the SSB beam. The UE may transmit, to the network entity via a physical random access channel (PRACH) mapped to the SSB beam, a random-access request at the RACH occasion. Subsequently, the UE may receive, from the network entity via the SSB beam, a RACH response in response to the random-access request. Because the UE selects the SSB beam based on the CLI measurement data, the UE may be able to select an SSB beam that is still useable for communication between the UE and the network entity but that has less CLI. This may reduce the chances that a RACH response from the network entity is corrupted by CLI, thereby improving the ability of the UE to join the network.

In one example, this disclosure describes a User Equipment (UE) for wireless communication, comprising: one or more memories; one or more processors coupled to the one or more memories, wherein the one or more processors are configured to: receive one or more Synchronization Signal Blocks (SSBs) broadcast by a network entity; generate cross-link interference (CLI) measurement data using resources corresponding to the one or more SSBs; select, based on the CLI measurement data, an SSB beam from among a plurality of SSB beams; determine, based on the one or more SSBs, a Random-Access Channel (RACH) occasion associated with the SSB beam; transmit, to the network entity via a PRACH mapped to the SSB beam, a random-access request at the RACH occasion; and receive, from the network entity via the SSB beam, a RACH response in response to the random-access request.

In another example, this disclosure describes a method of wireless communication, comprising: receiving, by a User Equipment (UE), one or more Synchronization Signal Blocks (SSBs) broadcast by a network entity; generating, by the UE, cross-link interference (CLI) measurement data using resources corresponding to the one or more SSBs; selecting, by the UE, based on the CLI measurement data, an SSB beam from among a plurality of SSB beams; determining, by the UE, based on the one or more SSBs, a Random-Access Channel (RACH) occasion associated with the SSB beam; and transmitting, by the UE to the network entity via a PRACH mapped to the SSB beam, a random-access request at the RACH occasion; and receiving, by the UE from the network entity via the SSB beam, a RACH response in response to the random-access request.

In another example, this disclosure describes an apparatus for wireless communication, comprising means for: receiving one or more Synchronization Signal Blocks (SSBs) broadcast by a network entity; generating cross-link interference (CLI) measurement data using resources corresponding to the one or more SSBs; selecting, based on the CLI measurement data, an SSB beam from among a plurality of SSB beams; determining, based on the one or more SSBs, a Random-Access Channel (RACH) occasion associated with the SSB beam; and transmitting, to the network entity via a PRACH mapped to the SSB beam, a random-access request at the RACH occasion; and receiving, from the network entity via the SSB beam, a RACH response in response to the random-access request.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication system according to some aspects of this disclosure.

FIG. 2 is a block diagram conceptually illustrating an example of a hardware implementation for a network node according to some aspects of this disclosure.

FIG. 3 is a block diagram illustrating a wireless communication system supporting multiple-input multiple-output (MIMO) communication according to some aspects of this disclosure.

FIG. 4 is a flow chart illustrating an exemplary process performed by a User Equipment (UE) in accordance with some aspects of the present disclosure.

FIG. 5 is a flow chart illustrating an exemplary process performed by a network entity in accordance with some aspects of the present disclosure.

FIG. 6 is a conceptual diagram illustrating types of cross-link interference (CLI).

FIG. 7 is a conceptual diagram illustrating CLI when a new UE attempts to join a network.

### DETAILED DESCRIPTION

Sub-band full duplex (SBFD) is a feature of 3rd-Generation Partnership Project (3GPP) wireless technologies for increased network spectrum efficiency. When a User Equipment (UE) and a network entity (e.g., a network node, base station, disaggregated base station, gNodeB (gNBs), etc.) are communicating using SBFD, bandwidth is split into a sub-band for an uplink (UL) channel and a sub-band for a down-link (DL) channel. The UE may transmit data to the network entity on the UL channel and another UE may concurrently receive data transmitted by the network entity on the DL channel. Cross-link interference (CLI) may occur between the UL channel and the DL channel. Handling and mitigating CLI is important in order to fully exploit the benefits of SBFD. In existing 3GPP technologies, a network configures the UE how to measure CLI and how to report the CLI to the network. The network may use reports of the CLI to adjust sub-bands, control access to the network, or other tasks. In the existing 3GPP technologies, the UE measures and reports the CLI after the UE has completed an initial access process to join the network. For instance, in Release 19 (R19) of the 3GPP 5G wireless communication technology, if a UE has already joined a network (or the UE is in a Radio Resource Control (RRC) connected state) a measurement and reporting mechanism for CLI mitigation is supported for pairing of beams and UEs.

In the initial access process, a UE may scan for available network entities and select one of the network entities (e.g., based on signal strength and quality). To facilitate such scanning and selection, network entities broadcast Synchronization Signal Blocks (SSBs). The SSBs carry data associated with a Physical Broadcast Channel (PBCH). The data associated with the PBCH includes system information such as cell identity, frequency configuration, and bandwidth information. More specifically, the data associated with the PBCH includes System Information Blocks (SIBs). The SIBs include Master Information Blocks (MIBs) and SIB1 blocks. In general, the data associated with the PBCH helps the UE determine a configuration of the network. A network entity may use massive multi-input multi-output (MIMO) antenna technologies to transmit and receive multiple directional radio signals (i.e., beams). The beams may be referred to as SSB beams. As part of the initial access process, the UE selects an SSB beam and selects one of the network entities.

After selecting a network entity and an SSB beam, the UE initiates communication with the network entity by sending a random-access request to the network entity using the selected SSB beam. The random-access request includes a randomly selected random-access preamble. The UE transmits that random-access request to the network entity using a random-access channel (RACH) carried on the SSB beam. The RACH is itself mapped to a Physical RACH (PRACH) on a physical layer of a communication stack. The PRACH is a set of physical resources (e.g., time and frequency resources) designated for transmission and reception of the RACH. The UE transmits the random-access request during a so-called RACH opportunity, which may also be referred to as a RACH occasion. A RACH opportunity is a time slot allocated by the network for UEs to initiate communication via the RACH. RACH opportunities may be periodic. UEs may determine RACH opportunities based on data signaled in the SIBs broadcast by the network entities, such as in SIB1 blocks.

The network entity responds to the random-access request with a random-access response that indicates resources allocated to the UE for communication with the network entity. The random-access response may include information that help the UE adjust its uplink transmission timing to be synchronized with the network. The random-access response also provides UL grant information that specifies resources that the UE may use for next transmissions. The UE may then transmit a connection request to the network entity using the specified resources. The connection request may provide information about the identity of the UE and information about why the UE is requesting access to join the network. The network entity may then use information in the connection request to allocate resources to the UE for UL and DL, thus concluding the initial access process.

Certain problems may arise in systems in which the UE measures and reports the CLI after the UE has completed the initial access process to join the network. For example, a network entity may already be serving other UEs in both UL and DL channels simultaneously. In this scenario, the network entity may have already scheduled the other UEs to use the UL channel using specific transmission configuration indication (TCI) states (e.g., beams), that are quasi-collocated (QCL) with SSB beams. As a result, after a UE sends a random-access request during a RACH opportunity, a RACH response (i.e., a random-access response) may arrive at the UE in a SBFD symbol that has severe CLI due to the ongoing UL traffic in the network. Because of the CLI, the UE may be unable to interpret the RACH response and may therefore be unable to use the RACH response to join the network. Thus, the UE may be a “victim” that is unable to join the network because the network entity is engaging in SBFD with the other UEs. The UE would then need to restart the initial access process, thereby wasting time and resource.

The techniques of this disclosure may address these problems. As noted above, the UE may be unable to join the network because CLI may corrupt the RACH response. The CLI is unknown to the UE because, in the existing 3GPP technologies, the UE measures and reports the CLI after completing of the initial access process. The techniques of this disclosure may enable the UE to assess the CLI environment to enhance initial access and may ensure faster full-duplex operation after joining the network. That is, the UE may measure CLI during the initial access process. The CLI measurements taken during the initial access process may then be used, by the UE and/or the network entity, to enhance the initial access process and/or ensure faster full-duplex operation.

In one example, a UE receives one or more SSBs broadcast by a network entity. The UE may generate CLI measurement data using resources corresponding to the one or more SSBs. The UE may select, based on the CLI measurement data, an SSB beam from among a plurality of SSB beams. The UE may also determine, based on the one or more SSBs, a RACH occasion associated with the SSB beam. The UE may transmit to the network entity, via a PRACH mapped to the SSB beam, a random-access request at the RACH occasion. The UE may then receive from the network entity, via the SSB beam, a RACH response in response to the random-access request. In this example, because the UE selects the SSB beam on which to transmit the random-access request based on the CLI measurement data, it may be less likely that the RACH response is corrupted by the CLI, thereby enabling the UE to join the network more efficiently. In some examples, the UE may also transmit CLI measurement data to the network entity as part of the initial access process. The network entity may use the CLI measurement data in allocating resources to the UE, such as resources for the UE to transmit a connection request.

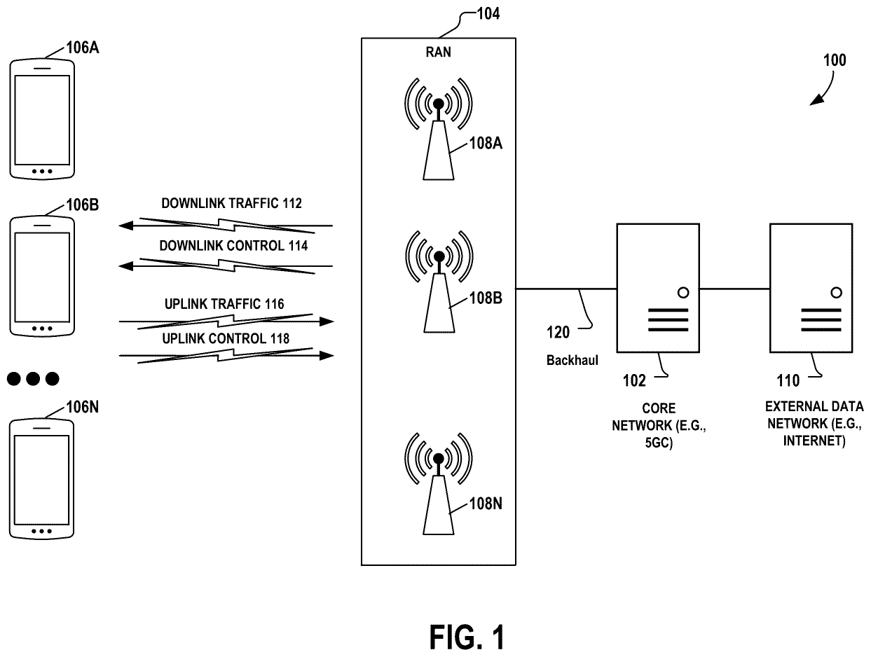

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and user equipments (UEs) 106A-106N (collectively, “UEs 106”). By virtue of the wireless communication system 100, UEs 106 may be enabled to carry out data communication with an external data network 110, such as (but not limited to) the Internet.

RAN 104 may implement any suitable wireless communication technology or technologies to provide radio access to UEs 106. As one example, RAN 104 may operate according to 3GPP New Radio (NR) specifications, often referred to as 5G or 5G NR. In some examples, RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, RAN 104 includes a plurality of network entities 108A-108N (collectively, “network entities 108”). Broadly, a network entity comprises one or more network elements in a radio access network responsible for radio transmission and reception in one or more cells to or from a UE. In different technologies, standards, or contexts, those skilled in the art may variously refer to a “network entity” as a network node, base station, a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a transmit receive point (TRP), or some other suitable terminology.

RAN 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (also known as a UE) need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant Quality of Service (QoS) for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network).

Wireless communication between a RAN 104 and UEs 106 may be described as utilizing an air interface. Transmissions over the air interface from a network entity (e.g., one of network entities 108) to one or more of UEs 106 may be referred to as downlink (DL) transmission. In accordance with certain aspects of the present disclosure, the term downlink may refer to a point-to-multipoint transmission originating at a scheduling entity, such as one or more of network entities 108. Another way to describe this scheme may be to use the term broadcast channel multiplexing. Transmissions from a UE (e.g., one of UEs 106) to a network entity (e.g., one of network entities 108) may be referred to as uplink (UL) transmissions. In accordance with further aspects of the present disclosure, the term uplink may refer to a point-to-point transmission originating at a scheduled entity (e.g., one of UEs 106).

In some examples, access to the air interface may be scheduled, wherein a scheduling entity (e.g., one of network entities 108) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs 106, which may be scheduled entities, may utilize resources allocated by scheduling entities, such as network entities 108. Network entities 108 and base stations are not the only entities that may function as scheduling entities. That is, in some examples, a UE or network entity may function as a scheduling entity, scheduling resources for one or more scheduled entities (e.g., one or more UEs).

As illustrated in FIG. 1, one or more of network entities 108 may broadcast downlink traffic 112 to one or more UEs 106. Broadly, each of network entities 108 may be a node or device responsible for scheduling traffic in a wireless communication network, including downlink traffic 112 and, in some examples, uplink traffic 116 from one or more UEs 106 to the network entity. On the other hand, each of UEs 106 may be a node or device that receives downlink control information 114, including but not limited to scheduling information (e.g., a grant), synchronization or timing information, or other control information from another entity in the wireless communication network such as the network entity.

In general, network entities 108 may include a backhaul interface for communication with a backhaul portion 120 of wireless communication system 100. Backhaul portion 120 may provide a link between network entities 108 and core network 102. Further, in some examples, backhaul portion 120 may provide interconnection between network entities 108. Various types of backhaul interfaces may be employed, such as a direct physical connection, a virtual network, or the like using any suitable transport network.

Core network 102 may be a part of wireless communication system 100 and may be independent of the radio access technology used in RAN 104. In some examples, core network 102 may be configured according to 5G standards (e.g., 5GC). In other examples, core network 102 may be configured according to a 4G evolved packet core (EPC), or any other suitable standard or configuration.

The air interface in RAN 104 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time utilizing a given resource. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

Deployment of communication systems, such as 5G new radio (NR) systems, may be arranged in multiple manners with various components or constituent parts. In a 5G NR system or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, gNB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

A UE, such as one of UEs 106, may perform a given initial access procedure to gain access to a cell and establish a radio resource control (RRC) connection with RAN 104. This initial access procedure may include a cell search procedure, a random-access procedure, and an RRC connection establishment procedure. To perform a cell search, the UE monitors certain established resources of physical broadcast channels (PBCH) known to carry synchronization signal blocks (SSB) transmitted by network entities 108. Once obtained, the UE can use the SSBs to synchronize with a network node and find the network node's Cell ID and acquire system information (SI) characterizing the cell. Network entities 108 may provide this system information by periodically broadcasting SSBs containing system information blocks (SIBs). Thus, the UE may obtain a master information block (MIB) from the PBCH carried on the SSBs, and a System Information Block type 1 (SIB1) from an identified data channel carried on the SSBs. Together, the MIB and SIB1 provide the UE with minimum system information (MSI) for cell access. The UE can acquire certain other system information (OSI) from further SIBs that network entities 108 of RAN 104 may broadcast periodically or send on-demand. The OSI may include any SI that is not broadcast in the MSI. In some examples, a Physical Downlink Shared Channel (PDSCH) may carry a plurality of SIBs, not limited to SIB1, discussed above. Here, RAN 104 may provide the OSI in these SIBs, e.g., SIB2 and above.

These operations provide the UE with sufficient RRC information to identify the cell's resources. However, to establish an RRC connection with the network node, the UE may perform a random-access procedure. Here, the UE and a network node (e.g., one of network entities 108) exchange information with one another and establish an RRC connection. Ongoing connection management for controlling a UE's connectivity status with the core network may be handled by way of higher layer signaling protocols (e.g., RRC).

Some modern wireless networks, such as a 5G NR network, may provide radio resources over a very wide frequency range. However, any given UE accessing a cell may have bandwidth capabilities that do not span this entire range. Accordingly, RAN 104 may configure a part or a portion of a carrier for that UE, called a bandwidth part (BWP), which has a bandwidth less than or equal to that UE's capabilities. RAN 104 may configure the UE with several BWPs (in some examples, up to four BWPs); although typically only a single BWP at a time is an active BWP. In this disclosure, a BWP refers to a set of wireless resources (e.g., a contiguous set of PRBs) selected as a subset of the wireless resources on a given carrier. In some examples, a BWP may be selected from among a contiguous set of resource blocks that share a common numerology (e.g., subcarrier spacing) on a given carrier. RAN 104 generally does not expect the UE to communicate outside an active BWP.

For purposes of explanation, this disclosure describes UE 106A as attempting to join RAN 104. As discussed above, a network entity (e.g., one of network entities 108) may already be serving other UEs (e.g., UEs 106B-106N) in both UL and DL channels simultaneously. As a result, after UE 106A sends a random-access request during a RACH opportunity, a RACH response (i.e., a random-access response) may arrive at UE 106A in a SBFD symbol that has severe CLI due to the ongoing UL traffic in RAN 104. Because of the CLI, UE 106A may be unable to interpret the RACH response and may therefore be unable to use the RACH response to join the network. Thus, UE 106A may be a “victim” that is unable to join the network because the network entity is engaging in SBFD with the other UEs 106B-106N. UE 106A would then need to restart the initial access process, thereby wasting time and resources.

The techniques of this disclosure may address these problems. As noted above, UE 106A may be unable to join the network because CLI may corrupt the RACH response. The CLI is unknown to UE 106A because, in the existing 3GPP technologies, UE 106A would measure and report the CLI after completing of the initial access process. The techniques of this disclosure may enable UE 106A to assess the CLI environment to enhance initial access and may ensure faster full-duplex operation after joining the network. That is, UE 106A may measure CLI during the initial access process. The CLI measurements taken during the initial access process may then be used, by UE 106A and/or the network entity, to enhance the initial access process and/or ensure faster full-duplex operation.

In one example, UE 106A receives one or more SSBs broadcast by a network entity (e.g., network entity 108A). UE 106A may generate CLI measurement data using resources corresponding to the one or more SSBs. UE 106A may select, based on the CLI measurement data, an SSB beam from among a plurality of SSB beams. UE 106A may also determine, based on the one or more SSBs, a RACH occasion associated with the SSB beam. UE 106A may transmit to network entity 108A, via a PRACH mapped to the SSB beam, a random-access request at the RACH occasion. UE 106A may then receive from network entity 108A, via the SSB beam, a RACH response in response to the random-access request. In this example, because UE 106A selects the SSB beam on which to transmit the random-access request based on the CLI measurement data, it may be less likely that the RACH response is corrupted by the CLI, thereby enabling UE 106A to join the network more efficiently. In some examples, UE 106A may also transmit CLI measurement data to network entity 108A as part of the initial access process. Network entity 108A may use the CLI measurement data in allocating resources to UE 106A, such as resources for UE 106A to transmit a connection request.

Similarly, network entity 108A may broadcast one or more SSBs. During an initial access process for UE 106A to join a network and during a RACH occasion, network entity 108A may receive, via a PRACH mapped to an SSB beam selected by UE 106A from among a plurality of SSB beams, a random-access request from UE 106A. During the initial access process, network entity 108A may receive CLI measurement data based on CLI measured by the UE on the one or more SSB beams. Additionally, during the initial access process, network entity 108A may transmit to UE 106A a RACH response in response to the random-access request.

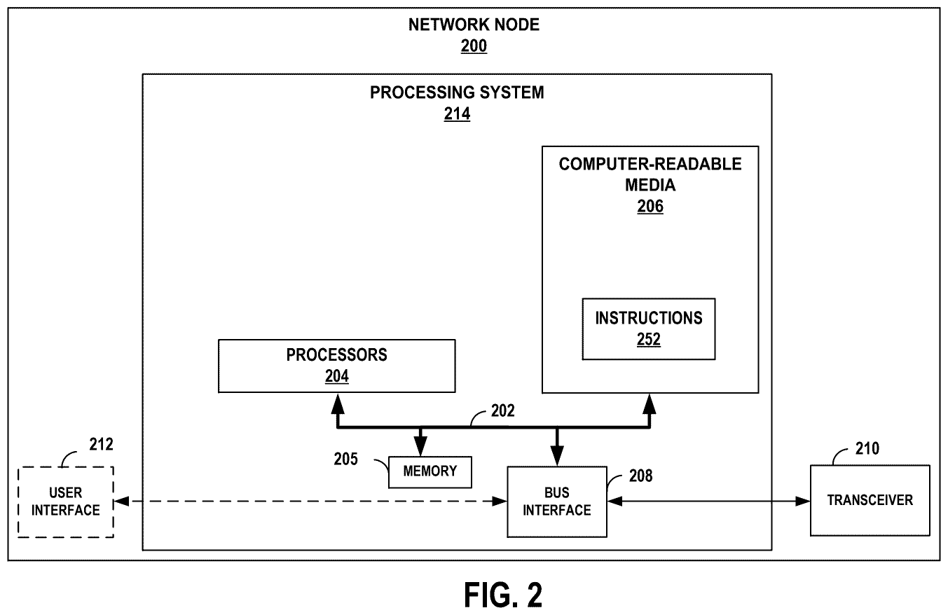

FIG. 2 is a block diagram illustrating an example of a hardware implementation for a network node 200 employing a processing system 214. For example, network node 200 may be a user equipment (UE) (e.g., one of UEs 106). In another example, network node 200 may be, or may be included in, a network entity (e.g., one of network entities 108).

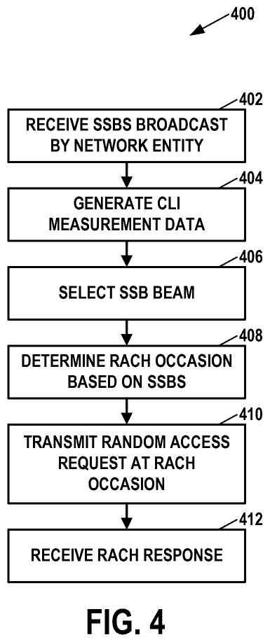

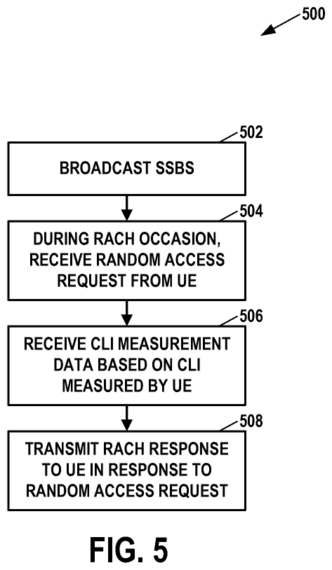

Network node 200 may include a processing system 214 having one or more processors 204. Examples of processors 204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, network node 200 may be configured to perform any one or more of the functions described herein. For example, processors 204 may be configured (e.g., in coordination with computer-readable storage media, such as memories 205 and/or computer-readable media 206) to implement any one or more of the processes and procedures described below and illustrated in FIG. 4 or FIG. 5.

Processing system 214 may be implemented with a bus architecture, represented generally by a bus 202. Bus 202 may include any number of interconnecting buses and bridges depending on the specific application of processing system 214 and the overall design constraints. Bus 202 communicatively couples together various circuits including one or more processors (represented generally by processors 204), one or more memories 205, and computer-readable media (represented generally by one or more computer-readable media 206). Bus 202 may also link various other circuits such as timing sources, peripherals, voltage regulators, and power management circuits, which are well known in the art, and therefore, will not be described any further. A bus interface 208 provides an interface between bus 202 and a transceiver 210. Transceiver 210 provides a communication interface or means for communicating with various other apparatus over a transmission medium. Depending upon the nature of the apparatus, a user interface 212 (e.g., keypad, display, speaker, microphone, joystick) may also be provided. Of course, such a user interface 212 is optional, and some examples, such as a base station, may omit it.

In some aspects of the disclosure, processors 204 may include circuitry configured (e.g., in coordination with memories 205 and/or computer-readable media 206) for various functions, including: receiving one or more SSBs broadcast by a network entity; generating CLI measurement data using resources corresponding to the one or more SSBs; selecting, based on the CLI measurement data, an SSB beam from among a plurality of SSB beams; determining, based on the one or more SSBs, a RACH occasion associated with the SSB beam; transmitting, to the network entity via a PRACH mapped to the SSB beam, a random-access request at the RACH occasion; and receiving, from the network entity via the SSB beam, a RACH response in response to the random-access request. In an example where a network entity includes network node 200, processors 204 may include circuitry configured to (e.g., in coordination with memories 205 and/or computer-readable media 206) for various functions, including: broadcasting, via transceiver 210, one or more SSBs; and during an initial access process for a UE to join a network: during a Random-access Channel (RACH) occasion, receive, via a PRACH mapped to an SSB beam selected by the UE from among a plurality of SSB beams, a random-access request from the UE; receiving, by the network entity, CLI measurement data based on CLI measured by the UE on the one or more SSB beams; and transmitting, by the network entity to the UE, a RACH response in response to the random-access request.

Processors 204 may be responsible for managing bus 202 and general processing, including the execution of software stored on computer-readable media 206. The software, when executed by processors 204, causes processing system 214 to perform the various functions described herein for any particular apparatus. Processors 204 may also use computer-readable media 206 and memories 205 for storing data that processors 204 manipulate when executing software. Software may be construed to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on computer-readable media 206. A computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random-access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Computer-readable media 206 may reside in processing system 214, external to processing system 214, or distributed across multiple entities including processing system 214. Computer-readable media 206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, computer-readable storage media 206 may store computer-executable code that includes instructions 252 that configure network node 200 for various functions, such as performing techniques of this disclosure. For example, instructions 252 may be configured to cause network node 200 to implement one or more of the functions described below in relation to FIG. 4 or FIG. 5.

In one configuration where network node is a UE, network node 200 includes means for receiving one or more SSBs broadcast by a network entity; generating CLI measurement data using resources corresponding to the one or more SSBs; selecting, based on the CLI measurement data, an SSB beam from among a plurality of SSB beams; determining, based on the one or more SSBs, a RACH occasion associated with the SSB beam; transmitting, to the network entity via a PRACH mapped to the SSB beam, a random-access request at the RACH occasion; and receiving, from the network entity via the SSB beam, a RACH response in response to the random-access request. In an example where a network entity includes network node 200, network node 200 includes means for broadcasting one or more SSBs; and during an initial access process for a UE to join a network: during a Random-access Channel (RACH) occasion, receive, via a PRACH mapped to an SSB beam selected by the UE from among a plurality of SSB beams, a random-access request from the UE; receiving, by the network entity, CLI measurement data based on CLI measured by the UE on the one or more SSB beams; and transmitting, by the network entity to the UE, a RACH response in response to the random-access request. In one aspect, the aforementioned means may include processors 204 and transceiver 210 configured to perform the functions recited by the aforementioned means. In another aspect, the aforementioned means may be a circuit or any apparatus configured to perform the functions recited by the aforementioned means.

In the above examples, the circuitry included in processors 204 is merely provided as an example, and other means for carrying out the described functions may be included within various aspects of the present disclosure, including but not limited to the instructions stored in computer-readable storage media 206, or any other suitable apparatus or means described in this disclosure and utilizing, for example, the processes described herein in relation to FIG. 4 and/or FIG. 5.

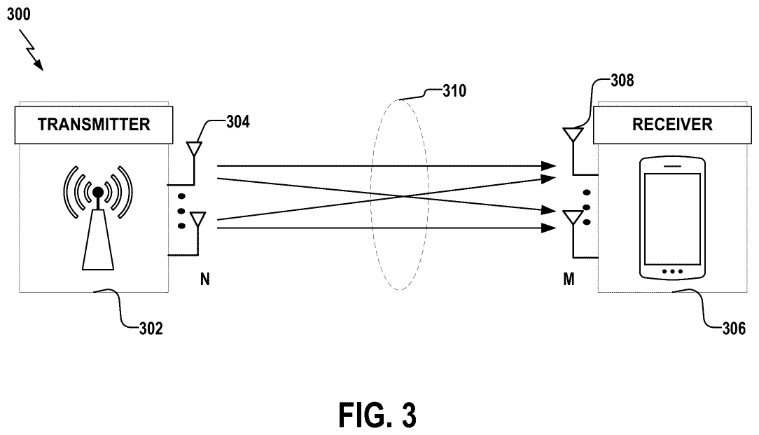

In some aspects of the disclosure, network entities 108 and UEs 106 may be configured with multiple antennas for beamforming and/or multiple-input multiple-output (MIMO) technology. FIG. 3 illustrates an example of a wireless communication system 300 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitting device may precode or control the amplitude and phase of each antenna in an array of antennas to create a desired (e.g., directional) pattern of constructive and destructive interference in the wavefront. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 210 from the transmit antennas 304 to the receive antennas 308. Each of transmitter 302 and receiver 306 may be implemented, for example, within one of network entities 108, one of UEs 106, or any other suitable wireless communication device. With reference to the example of FIG. 2, antennas 304 and/or antennas 308 may be coupled to transceiver 210.

In a MIMO system, spatial multiplexing may be used to transmit multiple different streams of data, also referred to as layers, simultaneously on the same time-frequency resource. In some examples, transmitter 302 may send multiple data streams to a single receiver. In this way, a MIMO system takes advantage of capacity gains and/or increased data rates associated with using multiple antennas in rich scattering environments where channel variations can be tracked. Here, receiver 306 may track these channel variations and provide corresponding feedback to transmitter 302. In one example case, as shown in FIG. 3, a rank-2 (i.e., including 2 data streams) spatial multiplexing transmission on a 2×2 MIMO antenna configuration will transmit two data streams via two transmit antennas 304. The signal from each transmit antenna 304 reaches each receive antenna 308 along a different signal path 310. Receiver 306 may then reconstruct the data streams using the received signals from each receive antenna 308.

Receiver 306 may apply a spatial filter when using a MIMO system. Spatial filters for MIMO systems may enhance signal quality and reduce interference by selectively processing signals based on their spatial characteristics. In some examples, the spatial filter is a spatial notch filter, which can reject interference from specific angles of arrival. Receiver 306 may implement a spatial notch filter using cascaded architectures or non-reciprocal phase shifters.

FIG. 4 is a flow chart illustrating an exemplary process 400 performed by a UE in accordance with some aspects of the present disclosure. As described below, a particular implementation may omit some or all illustrated features and may not require some illustrated features to implement all examples. For ease of explanation, this disclosure describes process 400 with respect to UE 106A (FIG. 1) and network entity 108A. In some examples, any suitable apparatus or means for carrying out the functions or algorithm described below may carry out process 400. UE 106A may perform process 400 as part of an initial access process to join a network.

In the example of FIG. 4, UE 106A receives one or more SSBs broadcast by network entity 108A (402). The SSBs may be associated with a plurality of SSB beams transmitted by network entity 108A. The SSBs may include a primary synchronization signal (PSS), a secondary synchronization signal (SSS), and may carry a PBCH. UE 106A may use the PSS to achieve time and frequency synchronization. UE 106A may use the SSS to derive full physical layer cell identity and additional synchronization information. The PBCH may include a master information block (MIB). The MIB may include Physical Downlink Control Channel (PDCCH) configuration that provides information about a Control Resource Set (CORESET) and search space for a System Information Block 1 (SIB1). UE 106A may detect the PSS and SSS for down-link synchronization and may obtain the MIB from the SSBs. UE 106A may then use the MIB to monitor the CORESET for remaining minimum system information (RMSI) reception.

UE 106A may generate CLI measurement data using resources corresponding to the one or more SSBs (404). For example, UE 106A may measure CLI in the resources corresponding to the SSBs broadcast by network entity 108 on each of the SSB beams.

UE 106A may measure the CLI in one of a variety of ways. For instance, in some examples, UE 106A may measure the CLI only within DL-usable physical resource blocks (PRBs) within a DL bandwidth part (BWP). In some examples, UE 106A may measure the CLI only within an uplink (UL)-usable PRBs within the DL BWP. In some examples, UE 106A may measure the CLI in the DL-usable PRBs and the UL-usable PRBs.

In some examples, UE 106A transmits to network entity 108A UE capability information during the initial access process. In some examples, the UE capability information may include one or more of data indicating whether UE 106A is configured to support CLI measurement and reporting as part of RACH messaging. In some examples, the UE capability information may include a maximum CLI measurement resources rate that UE 106A is currently configured to buffer. The maximum CLI measurement resources rate may be one of: a maximum number of CLI measurement resources per slot, a maximum number of CLI measurement resources per component carrier (CC), or a maximum number of CLI measurement resources across CC. In some examples, the UE capability information may include a maximum CLI resources rate that UE 106A is able to be configured to buffer. The maximum number of CLI resources rate may indicate a maximum number of CLI resources that UE 106A is able to be configured to buffer per slot, per DL BWP, per CC, or across CC. In some examples, the UE capability information may include CLI report granularity information. The CLI report granularity information may indicate the granularity at which UE 106A is able to provide CLI measurement data. For instance, the CLI report granularity information may indicate that UE 106A is able to provide CLI measurement data at a wideband level, at a sub-band level, at a specific range, and so on. Network entity 108A may use the UE capability information to determine how to allocate resources to UE 106A.

Furthermore, in the example of FIG. 4, UE 106A may select, based on the CLI measurement data, an SSB beam from among the plurality of SSB beams (406). For instance, UE 106A may select the SSB beam that is associated with a least amount of CLI. In some examples, UE 106A may receive select the SSB beam with a best reference signal received power (RSRP).

Additionally, UE 106A may determine, based on the one or more SSBs, a RACH occasion associated with the SSB beam (408). To determine the RACH occasion, UE 106A may read a SIB, which contains a RACH configuration. The RACH configuration includes details such as a PRACH configuration index, a root sequence index, and other parameters. Additionally, UE 106A may measure a Reference Signal Received Power (RSRP) of Synchronization Signal/Physical Broadcast Channel (SS/PBCH) blocks. These blocks are associated with specific RACH occasions. The network may specify how SS/PBCH blocks are mapped to RACH occasions. UE 106A may use the PRACH configuration index to determine the time and frequency resources for the RACH occasion.

UE 106A may transmit to network entity 108A, via a PRACH mapped to the SSB beam, a random-access request at the RACH occasion (410). The random-access request may include a random-access preamble. UE 106A may receive from network entity 108A, via the SSB beam, a RACH response in response to the random-access request (412). The RACH response may include timing information, a temporary identifier for UE 106A, and uplink grant information that specifies the resources that UE 106A can use for the next transmission of UE 106A.

In some examples, the RACH response indicates one or more CLI measurement resources and one or more CLI reporting resources. UE 106A may generate CLI measurement data based on CLI measured by UE 106 in the one or more CLI measurement resources. UE 106A may transmit to network entity 108A the CLI measurement data using the one or more CLI reporting resources. In some such examples, UE 106A may generate second CLI measurement data that is in addition to the first CLI measurement data that UE 106A used to select the SSB beam. In some examples, the CLI measurement resources can be aperiodic measurement resources configured on SBFD symbols and can have a quasi-co-location (QCL) relationship with the SSB beams. In some examples, a random-access response can be used to identify the locations of SBFD UL/DL sub-bands from one or multiple existing UEs that the network entity may assume to cause CLI to the new UE. In some examples, the random-access response may trigger CLI reporting from the new UE. In some examples, dedicated RACH occasions may be assigned per SSB for supporting this feature of (configured/dynamic) CLI measurement resource mapping/indication and reporting during initial access. The RACH occasions may be in non-SBFD symbols or existing SBFD symbols. The non-SBFD symbols are symbols that are half duplex, e.g., legacy symbols, symbols reserved only for DL use, symbols reserved only for UL use, or symbols that are flexibly reserved for either DL or UL use. In some examples, the PRACH parameters for use during such dedicated ROs may be based on the symbol type or separately specified/configured for CLI measurement and reporting during initial access.

In other examples, UE 106A does not select the SSB beam based on CLI measurement data. In such examples, UE 106A may transmit the CLI measurement data to network entity 108A in a connection request or in another transmission during the initial access process for UE 106A to join the network. In any of these examples, network entity 108A may use the CLI measurement data to determine how to allocate resources to UE 106A.

In some examples, UE 106A may receive CLI configuration information from network entity 108A. The CLI configuration information configures UE 106A to measure the CLI on one or more CLI measurement resources. The one or more CLI measurement resources are mapped to the one or more SSBs. In other words, the CLI configuration information configures UE 106A to measure the CLI on resources associated with specific SSBs. In some examples, the one or more CLI measurement resources include periodic measurement resources configured on SBFD symbols and quasi-collocated with the SSB beams. In some examples, UE 106A receives the CLI configuration information in a message broadcast by network entity 108A. In some examples, UE 106A receives the CLI configuration information as part of an on-demand SIB requested by UE 106A. Receiving the CLI configuration information in this way may enable UE 106A to measure the CLI at appropriate CLI measurement resources, which may therefore help UE 106A join the network more efficiently. Receiving the CLI configuration information as part of an on-demand SIB may allow the CLI configuration information to be transmitted without adding a new type of message which could increase complexity.

In some examples, the CLI configuration information includes locations of SBFD UL and/or DL sub-bands. Furthermore, in some examples, the CLI information specifies beam-specific mappings of CLI measurement resources to SSBs. That is, the CLI information may specify that different CLI measurement resources are to be used for measuring CLI in different SSB beams. Such beam-specific mappings may be signaled in a broadcast message in a SIB, in Remaining Minimum System Information (RMSI), or in Open System Interconnection (OSI) information. For example, if an SSB direction is already supporting SBFD to an existing UE in the network, the network entity may indicate that a message (e.g., a random access request or a connection request) received from the UE may be impacted by the CLI. In some examples, the mapping of SSB to CLI measurement resources may be a one-to-many mapping. For example, if a same SSB beam direction has multiple P2 (i.e., refined, narrow beams sent by the network entity) beams used for UL reception from multiple existing UEs, then a new UE may experience different CLI levels in the associated receiving beam directions associated with different P2 beams due to UL transmissions from different existing UEs.

In some examples, UE 106A receives CLI configuration information that specifies, for each SSB beam of the plurality of SSB beams, one or more RACH occasions for the SSB beam. UE 106A may generate the CLI measurement data for each of the SSB beams based on CLI measured by the UE on each of the SSB beams. For each of the SSB beams, UE 106A may transmit, to the network entity, the CLI measurement data for the SSB beam during the one or more RACH occasions for the SSB beam.

In some examples where UE 106A receives CLI configuration information from network entity 108A, the CLI configuration information configures UE 106A to measure CLI on CLI measurement resources, where the CLI measurement resources are mapped to the one or more SSBs. In some such examples, UE 106A receives the one or more SSBs using a spatial filter. Before sending the random-access request, UE 106A may generate the CLI measurement data based on CLI measured by UE 106A, while using the spatial filter, in the CLI measurement resources.

Furthermore, in some examples where UE 106A receives CLI configuration information from network entity 108A, UE 106A may receive the one or more SSBs using a spatial filter. UE 106A may generate the CLI measurement data based on CLI measured by the UE, while using the spatial filter, in the CLI measurement resources. The random-access request or a connection request sent by UE 106A to network entity 108A after the random-access request includes the CLI measurement data. In some examples, UE 106A may transmit the CLI measurement data in a MsgA PUSCH (e.g., a random-access request).

In some examples, the CLI measurement data may contain at least one of CLI resource identifier. The CLI measurement data may be formatted in a reporting format and with a specified granularity. For instance, the measurement report range, quantization, and bit-width can reuse the existing definitions for a connected mode UE (e.g., the UE after completion of the initial access process). In some examples, the measurement report range, quantization, bit-width are cell specific and broadcast as part of SI. In some examples, the measurement report range, quantization, and/or bit-width are SSB beam specific and are configurable by the network or signaled based on a UE request.

FIG. 5 is a flow chart illustrating an exemplary process 500 performed by a network entity in accordance with some aspects of the present disclosure. For ease of explanation, this disclosure describes process 400 with respect to UE 106A and network entity 108A. In the example of FIG. 5, network entity 108A broadcasts one or more SSBs (502). The SSBs may include a PSS, a SSS, and may carry a PBCH. UE 106A may detect the PSS and SSS for down-link synchronization and may obtain the MIB from the SSBs.

During an initial access process for UE 106A to join a network and during a RACH occasion, network entity 108A may receive, via a PRACH mapped to an SSB beam selected by UE 106A from among a plurality of SSB beams, a random-access request from UE 106A (804). The random-access request may include a random-access preamble.

Additionally, during the initial access process for UE 106A to join the network, network entity 108A may receive CLI measurement data based on CLI measured by UE 106A on the one or more SSBs (806). In some examples, network entity 108A receives the CLI measurement data from UE 106A in the random-access request. In some examples, network entity 108A receives the CLI measurement data from UE 106A prior to receiving the random-access request. In some examples, network entity 108A receives the CLI measurement data after receiving the random-access request but still during the initial access process for UE 106A to join the network.

Furthermore, during the initial access process for UE 106A to join the network, network entity 108A may transmit a RACH response to UE 106A in response to the random-access request (808). The RACH response may include timing information, a temporary identifier for UE 106A, and uplink grant information that specifies the resources that UE 106A can use for the next transmission of UE 106A.

In some examples, the RACH response indicates one or more CLI measurement resources in which UE 106A is to measure the CLI and one or more CLI reporting resources in which UE 106A is to transmit the CLI measurement data. Thus, in such examples, network entity 108A may receive the CLI measurement data after transmitting the RACH response but still during the initial access process for UE 106A to join the network. For example, network entity 108A may receive the CLI measurement data before receiving a connection request from UE 106A. In another example, network entity 108A may receive the CLI measurement data as part of receiving the connection request from UE 106A.

The network entity may transmit CLI configuration data to the UE. The CLI configuration data may configure the UE how to measure and report CLI. For instance, the CLI configuration data may configure UE 106A to measure the CLI on one or more CLI measurement resources, where the CLI measurement resources are mapped to one or more SSBs. Furthermore, in some examples, the one or more CLI measurement resources include periodic measurement resources configured on SBFD symbols and quasi-collocated with the SSB beams. In some examples, the CLI configuration data configures UE 106A to measure the CLI using a same spatial filter that UE 106A uses to receive the SSBs. Using the same spatial filter in this way may help to ensure that UE 106A is measuring CLI on the same SSB beam that UE 106A would use to transmit a random access request.

In some examples, the network entity transmits different CLI configuration data for each SSB beam of a plurality of SSB beams. For instance, in some examples, UE 108A transmits CLI configuration information to UE 106A that specifies, for each SSB beam of the plurality of SSB beams, one or more RACH occasions for the SSB beam. Network entity 108A may receive CLI measurement data for each of the SSB beams based on CLI measured by UE 106 on each of the SSB beams.

In some examples, UE 108A broadcasts a message that includes the CLI configuration information. In some examples, UE 108A transmits the CLI configuration information in response to a request from UE 108A for a system information block (SIB).

In some examples, network entity 108A receives, from UE 106A, UE capability information during the initial access process. In some examples, the UE capability information may include one or more of data indicating whether UE 106A is configured to support CLI measurement and reporting as part of RACH messaging. In some examples, the UE capability information may include a maximum CLI measurement resources rate that UE 106A is currently configured to buffer. The maximum CLI measurement resources rate may be one of: a maximum number of CLI measurement resources per slot, a maximum number of CLI measurement resources per component carrier (CC), or a maximum number of CLI measurement resources across CC. In some examples, the UE capability information may include a maximum CLI resources rate that UE 106A is able to be configured to buffer. The maximum number of CLI resources rate may indicate a maximum number of CLI resources that UE 106A is able to be configured to buffer per slot, per DL BWP, per CC, or across CC. In some examples, the UE capability information may include CLI report granularity information. The CLI report granularity information may indicate the granularity at which UE 106A is able to provide CLI measurement data. For instance, the CLI report granularity information may indicate that UE 106A is able to provide CLI measurement data at a wideband level, at a sub-band level, at a specific range, and so on. Network entity 108A may use the UE capability information to determine how to allocate resources to UE 106A.

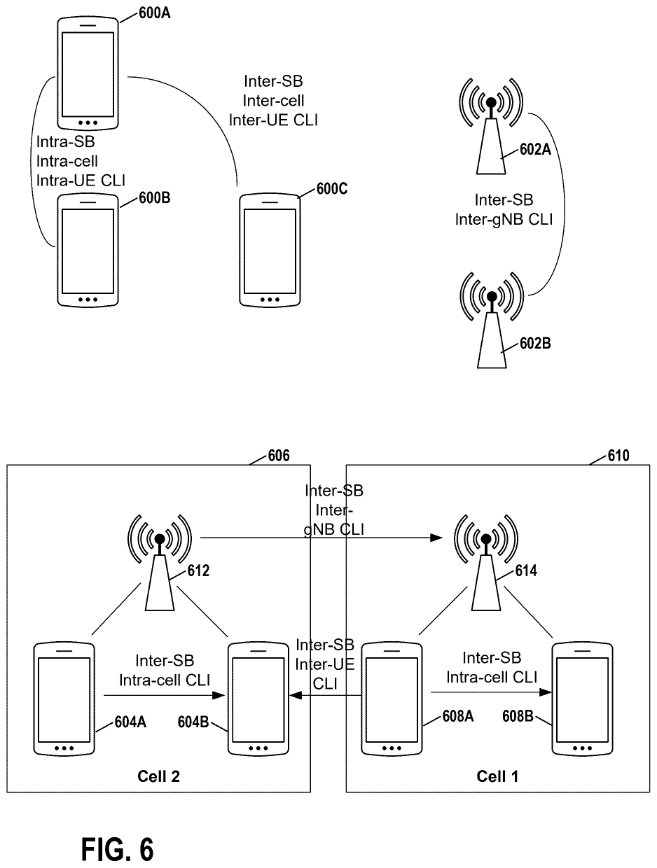

FIG. 6 is a conceptual diagram illustrating types of CLI. In the example of FIG. 6, inter-sub-band CLI, intra-cell CLI, and intra-UE CLI may occur between UEs, such as UEs 600A, 600B, on both uplink and downlink. Likewise, inter-sub-band CLI, inter-cell-CLI, and inter-UE CLI may occur due to concurrent transmissions of UEs, such as UE 600A and 600C. Inter-sub-band CLI and inter-gNB (e.g., inter-network entity) CLI may occur due to concurrent transmissions of network entities, such as gNBs 602A and 602B, on both uplink and downlink. Similarly, inter-sub-band CLI and intra-cell CLI may occur due to concurrent transmissions of 604A and 604B in a cell 606; inter-sub-band CLI and intra-cell CLI may occur due to concurrent transmissions of UEs 608A and 608B in a cell 610. Inter-sub-band CLI, inter-cell CLI, and inter-UE CLI may occur due to concurrent transmissions of UEs in different cells, such as UE 604B and UE 608A. Inter-sub-band CLI and Inter-gNB CLI may occur due to concurrent transmissions of gNBs 612 and 614.

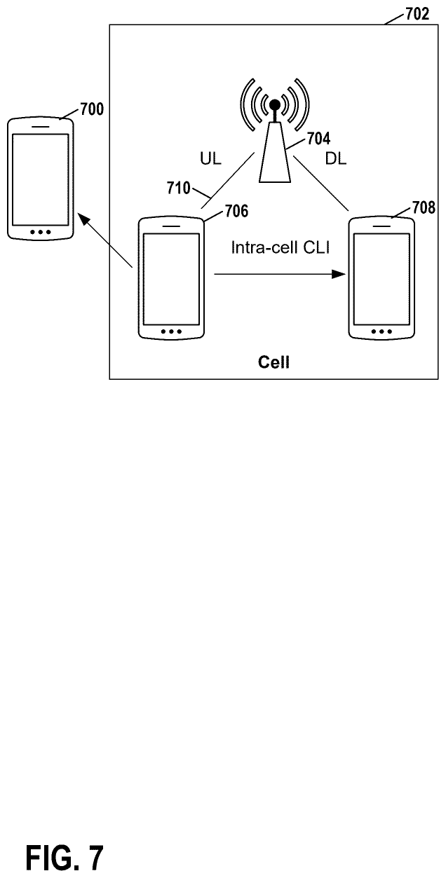

FIG. 7 is a conceptual diagram illustrating CLI when a new UE 700 attempts to join a network. In the example of FIG. 7, a new UE 700 attempts to join a cell 702 having a network entity 704. Intra-cell CLI caused by concurrent transmissions of UEs 706 and 708 already in the network may disrupt the ability of new UE 700 to receive an SSB beam 710 used for initial access.

The following is a non-limiting list of clauses describing techniques of this disclosure.

Clause 1. A User Equipment (UE) for wireless communication, comprising: one or more memories; one or more processors coupled to the one or more memories, wherein the one or more processors are configured to: receive one or more Synchronization Signal Blocks (SSBs) broadcast by a network entity; generate cross-link interference (CLI) measurement data using resources corresponding to the one or more SSBs; select, based on the CLI measurement data, an SSB beam from among a plurality of SSB beams; determine, based on the one or more SSBs, a Random-Access Channel (RACH) occasion associated with the SSB beam; transmit, to the network entity via a PRACH mapped to the SSB beam, a random-access request at the RACH occasion; and receive, from the network entity via the SSB beam, a RACH response in response to the random-access request.

Clause 2. The UE of clause 1, wherein the one or more processors are further configured to: receive CLI configuration information from the network entity, wherein the CLI configuration information configures the UE to measure the CLI on one or more CLI measurement resources, wherein the one or more CLI measurement resources are mapped to the one or more SSBs.

Clause 3. The UE of clause 2, wherein the one or more CLI measurement resources include periodic measurement resources configured on sub-band full duplex (SBFD) symbols and quasi-collocated with the SSB beams.

Clause 4. The UE of any of clauses 2-3, wherein: to receive the CLI configuration information, the one or more processors are configured to receive the CLI configuration information in a message broadcast by the network entity, or to receive the CLI configuration information, the one or more processors are configured to receive the CLI configuration information as part of an on-demand system information block (SIB) requested by the UE.

Clause 5. The UE of any of clauses 1-4, wherein: the RACH response indicates one or more CLI measurement resources and one or more CLI reporting resources, and the one or more processors are further configured to: generate second CLI measurement data based on CLI measured by the UE in the one or more CLI measurement resources; and transmit, to the network entity, the second CLI measurement data using the one or more CLI reporting resources.

Clause 6. The UE of any of clauses 1-5, wherein: the one or more processors are further configured to receive CLI configuration information that specifies, for each SSB beam of the plurality of SSB beams, one or more RACH occasions for the SSB beam; to generate the CLI measurement data, the one or more processors are configured to generate the CLI measurement data for each of the SSB beams based on CLI measured by the UE on each of the SSB beams, and the one or more processors are further configured to, for each of the SSB beams, transmit, to the network entity, the CLI measurement data for the SSB beam during the one or more RACH occasions for the SSB beam.

Clause 7. The UE of any of clauses 1-6, wherein: the one or more processors are further configured to receive, from the network entity, CLI configuration information, the CLI configuration information configuring the UE to measure CLI on CLI measurement resources, wherein the CLI measurement resources are mapped to the one or more SSBs, to receive the one or more SSBs, the one or more processors are configured to receive the one or more SSBs using a spatial filter, and to generate the CLI measurement data, the one or more processors are configured to, before sending the random-access request, generate the CLI measurement data based on CLI measured by the UE, while using the spatial filter, in the CLI measurement resources.

Clause 8. The UE of any of clauses 1-7, wherein: the one or more processors are further configured to receive CLI configuration information from the network entity, the CLI configuration information indicating CLI measurement resources in which to measure CLI; to receive the one or more SSBs, the one or more processors are configured to receive the one or more SSBs using a spatial filter, to generate the CLI measurement data, the one or more processors are configured to generate the CLI measurement data based on CLI measured by the UE, while using the spatial filter, in the CLI measurement resources, the random-access request or a message sent by the UE to the network entity after the random-access request includes the CLI measurement data.

Clause 9. The UE of any of clauses 1-8, wherein to obtain the CLI measurement data, the one or more processors are configured to: measure CLI only within downlink (DL)-usable physical resource blocks (PRBs) within a DL bandwidth part (BWP), measure the CLI only within an uplink (UL)-usable PRBs within the DL BWP, or measure the CLI in the DL-usable PRBs and the UL-usable PRBs.

Clause 10. The UE of any of clauses 1-9, wherein the one or more processors are further configured to: transmit, to the network entity, UE capability information during an initial access process, where the UE capability information includes one or more of: data indicating whether the UE is configured to support CLI measurement and reporting as part of RACH messaging, a maximum CLI measurement resources rate that the UE is currently configured to buffer, wherein the maximum CLI measurement resources rate is one of: a maximum number of CLI measurement resources per slot, a maximum number of CLI measurement resources per component carrier (CC), or a maximum number of CLI measurement resources across CC, a maximum CLI resources rate that the UE is able to be configured to buffer, or CLI report granularity information.

Clause 11. A network entity for wireless communication, comprising: one or more memories; a transceiver; and one or more processors coupled to the one or more memories and the transceiver, the one or more processors configured to: broadcast one or more Synchronization Signal Blocks (SSBs); and during an initial access process for a User Equipment (UE) to join a network: during a Random-access Channel (RACH) occasion, receive, via a Physical Random-access Channel (PRACH) mapped to an SSB beam selected by the UE from among a plurality of SSB beams, a random-access request from the UE; receive cross-link interference (CLI) measurement data based on CLI measured by the UE on the one or more SSBs; and transmit, to the UE, a RACH response in response to the random-access request.

Clause 12. The network entity of clause 11, wherein the one or more processors are further configured to: transmit CLI configuration information to the UE, wherein the CLI configuration information configures the UE to measure the CLI on one or more CLI measurement resources, and the one or more CLI measurement resources are mapped to the one or more SSBs.

Clause 13. The network entity of clause 12, wherein the one or more CLI measurement resources include periodic measurement resources configured on sub-band full duplex (SBFD) symbols and quasi-collocated with the SSB beams.

Clause 14. The network entity of any of clauses 12-13, wherein: to transmit the CLI configuration information, the one or more processors are configured to broadcast, via the transceiver, a message that includes the CLI configuration information, or to transmit the CLI configuration information, the one or more processors are configured to transmit the CLI configuration information in response to a request from the UE for a system information block (SIB).

Clause 15. The network entity of any of clauses 11-14, wherein the RACH response indicates one or more CLI measurement resources in which the UE is to measure the CLI and one or more CLI reporting resources in which the UE is to transmit the CLI measurement data.

Clause 16. The network entity of any of clauses 11-15, wherein: the one or more processors are further configured to transmit CLI configuration information to the UE that specifies, for each SSB beam of the plurality of SSB beams, one or more RACH occasions for the SSB beam, and to receive the CLI measurement data, the one or more processors are configured to receive CLI measurement data for each of the SSB beams based on CLI measured by the UE on each of the SSB beams.

Clause 17. The method of any of clauses 11-16, wherein: the one or more processors are further configured to transmit CLI configuration information to the UE that configures the UE to measure CLI on CLI measurement resources, wherein the CLI measurement resources are mapped to the one or more SSBs, the UE measures the CLI is measured using a same spatial filter that the UE uses to receive the one or more SSBs.

Clause 18. The method of any of clauses 11-17, wherein the one or more processors are further configured to: receive, from the UE, UE capability information during the initial access process, where the UE capability information includes one or more of: data indicating whether the UE is configured to support CLI measurement and reporting as part of RACH messaging, a maximum CLI measurement resources rate that the UE is currently configured to buffer, wherein the maximum CLI measurement resources rate is one of: a maximum number of CLI measurement resources per slot, a maximum number of CLI measurement resources per component carrier (CC), or a maximum number of CLI measurement resources across CC, a maximum number of CLI resources rate that the UE is able to be configured to buffer, or CLI report granularity information.

Clause 19. A method of wireless communication, comprising: receiving, by a User Equipment (UE), one or more Synchronization Signal Blocks (SSBs) broadcast by a network entity; generating, by the UE, cross-link interference (CLI) measurement data using resources corresponding to the one or more SSBs; selecting, by the UE, based on the CLI measurement data, an SSB beam from among a plurality of SSB beams; determining, by the UE, based on the one or more SSBs, a Random-Access Channel (RACH) occasion associated with the SSB beam; transmitting, by the UE to the network entity via a PRACH mapped to the SSB beam, a random-access request at the RACH occasion; and receiving, by the UE from the network entity via the SSB beam, a RACH response in response to the random-access request.

Clause 20. The method of clause 19, further comprising: receiving, by the UE, CLI configuration information from the network entity, wherein the CLI configuration information configures the UE to measure the CLI on one or more CLI measurement resources, wherein the one or more CLI measurement resources are mapped to the one or more SSBs.

Clause 21. The method of clause 20, wherein the one or more CLI measurement resources include periodic measurement resources configured on sub-band full duplex (SBFD) symbols and quasi-collocated with the SSB beams.

Clause 22. The method of any of clauses 20-21, wherein: the receiving the CLI configuration information comprises receiving the CLI configuration information in a message broadcast by the network entity, or the receiving the CLI configuration information comprises receiving the CLI configuration information as part of an on-demand system information block (SIB) requested by the UE.

Clause 23. The method of any of clauses 19-22, wherein: the RACH response indicates one or more CLI measurement resources and one or more CLI reporting resources, and the method further comprises: generating, by the UE, second CLI measurement data based on CLI measured by the UE in the one or more CLI measurement resources; and transmitting, by the UE to the network entity, the second CLI measurement data using the one or more CLI reporting resources.

Clause 24. The method of any of clauses 19-23, wherein: the method further comprises receiving CLI configuration information that specifies, for each SSB beam of the plurality of SSB beams, one or more RACH occasions for the SSB beam; generating the CLI measurement data comprises generating the CLI measurement data for each of the SSB beams based on CLI measured by the UE on each of the SSB beams, and the method further comprises, for each of the SSB beams, transmitting, by the UE to the network entity, the CLI measurement data for the SSB beam during the one or more RACH occasions for the SSB beam.

Clause 25. The method of any of clauses 19-24, wherein: the method further comprises receiving, by the UE from the network entity, CLI configuration information, the CLI configuration information configuring the UE to measure CLI on CLI measurement resources, wherein the CLI measurement resources are mapped to the one or more SSBs, receiving the one or more SSBs comprises receiving, by the UE, the one or more SSBs using a spatial filter, and generating the CLI measurement data comprises, before sending the random-access request, generating, by the UE, the CLI measurement data based on CLI measured by the UE, while using the spatial filter, in the CLI measurement resources.

Clause 26. The method of any of clauses 19-25, wherein: the method further comprises receiving, by the UE, CLI configuration information from the network entity, the CLI configuration information indicating CLI measurement resources in which to measure CLI; receiving the one or more SSBs comprises receiving, by the UE, the one or more SSBs using a spatial filter, generating the CLI measurement data comprises generating, by the UE, the CLI measurement data based on CLI measured by the UE, while using the spatial filter, in the CLI measurement resources, the random-access request or a message sent by the UE to the network entity after the random-access request includes the CLI measurement data.

Clause 27. The method of any of clauses 19-26, wherein obtaining the CLI measurement data comprises one of: measuring, by the UE, CLI only within downlink (DL)-usable physical resource blocks (PRBs) within a DL bandwidth part (BWP), measuring, by the UE, the CLI only within an uplink (UL)-usable PRBs within the DL BWP, or measuring, by the UE, the CLI in the DL-usable PRBs and the UL-usable PRBs.

Clause 28. The method of any of clauses 19-27, further comprising: transmitting, by the UE to the network entity, UE capability information during an initial access process, where the UE capability information includes one or more of: data indicating whether the UE is configured to support CLI measurement and reporting as part of RACH messaging, a maximum CLI measurement resources rate that the UE is currently configured to buffer, wherein the maximum CLI measurement resources rate is one of: a maximum number of CLI measurement resources per slot, a maximum number of CLI measurement resources per component carrier (CC), or a maximum number of CLI measurement resources across CC, a maximum CLI resources rate that the UE is able to be configured to buffer, or CLI report granularity information.

Clause 29. A method of wireless communication, comprising: broadcasting, by a network entity, one or more Synchronization Signal Blocks (SSBs); and during an initial access process for a User Equipment (UE) to join a network: during a Random-access Channel (RACH) occasion, receiving, by the network entity via a Physical Random-access Channel (PRACH) mapped to an SSB beam selected by the UE from among a plurality of SSB beams, a random-access request from the UE; receiving, by the network entity, cross-link interference (CLI) measurement data based on CLI measured by the UE on the one or more SSBs; and transmitting, by the network entity to the UE, a RACH response in response to the random-access request.

Clause 30. The method of clause 29, further comprising: transmitting, by the network entity, CLI configuration information to the UE, wherein the CLI configuration information configures the UE to measure the CLI on one or more CLI measurement resources, and the one or more CLI measurement resources are mapped to the one or more SSBs.

Clause 31. The method of clause 30, wherein the one or more CLI measurement resources include periodic measurement resources configured on sub-band full duplex (SBFD) symbols and quasi-collocated with the SSB beams.

Clause 32. The method of any of clauses 30-31, wherein: the transmitting the CLI configuration information comprises broadcasting, by the network entity, a message that includes the CLI configuration information, or the transmitting the CLI configuration information comprises transmitting, by the network entity, the CLI configuration information in response to a request from the UE for a system information block (SIB).

Clause 33. The method of any of clauses 29-32, wherein the RACH response indicates one or more CLI measurement resources in which the UE is to measure the CLI and one or more CLI reporting resources in which the UE is to transmit the CLI measurement data.

Clause 34. The method of any of clauses 29-33, wherein: the method further comprises transmitting, by the network entity, CLI configuration information to the UE that specifies, for each SSB beam of the plurality of SSB beams, one or more RACH occasions for the SSB beam, and receiving the CLI measurement data comprises receiving CLI measurement data for each of the SSB beams based on CLI measured by the UE on each of the SSB beams.

Clause 35. The method of any of clauses 29-34, wherein: the method further comprises transmitting, by the network entity, CLI configuration information to the UE that configures the UE to measure CLI on CLI measurement resources, wherein the CLI measurement resources are mapped to the one or more SSBs, the UE measures the CLI is measured using a same spatial filter that the UE uses to receive the one or more SSBs.

Clause 36. The method of any of clauses 29-35, further comprising: receiving, by the network entity from the UE, UE capability information during the initial access process, where the UE capability information includes one or more of: data indicating whether the UE is configured to support CLI measurement and reporting as part of RACH messaging, a maximum CLI measurement resources rate that the UE is currently configured to buffer, wherein the maximum CLI measurement resources rate is one of: a maximum number of CLI measurement resources per slot, a maximum number of CLI measurement resources per component carrier (CC), or a maximum number of CLI measurement resources across CC, a maximum number of CLI resources rate that the UE is able to be configured to buffer, or CLI report granularity information.

Clause 37. An apparatus for wireless communication, comprising means for performing the methods of any of clauses 20-36.

Clause 38. A non-transitory computer-readable medium storing computer-executable code, comprising code for causing a computer to perform the methods of any of clauses 20-36.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chips (ICs) and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described techniques. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-5 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-5 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; a, b and c; and so on. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A User Equipment (UE) for wireless communication, comprising:
one or more memories;
one or more processors coupled to the one or more memories, wherein the one or more processors are configured to:
receive one or more Synchronization Signal Blocks (SSBs) broadcast by a network entity;
generate cross-link interference (CLI) measurement data using resources corresponding to the one or more SSBs;
select, based on the CLI measurement data, an SSB beam from among a plurality of SSB beams;
determine, based on the one or more SSBs, a Random-Access Channel (RACH) occasion associated with the SSB beam;
transmit, to the network entity via a PRACH mapped to the SSB beam, a random-access request at the RACH occasion; and
receive, from the network entity via the SSB beam, a RACH response in response to the random-access request.

2. The UE of claim 1, wherein the one or more processors are further configured to:
receive CLI configuration information from the network entity, wherein the CLI configuration information configures the UE to measure the CLI on one or more CLI measurement resources, wherein the one or more CLI measurement resources are mapped to the one or more SSBs.

3. The UE of claim 2, wherein the one or more CLI measurement resources include periodic measurement resources configured on sub-band full duplex (SBFD) symbols and quasi-collocated with the SSB beams.

4. The UE of claim 2, wherein:
to receive the CLI configuration information, the one or more processors are configured to receive the CLI configuration information in a message broadcast by the network entity, or
to receive the CLI configuration information, the one or more processors are configured to receive the CLI configuration information as part of an on-demand system information block (SIB) requested by the UE.

5. The UE of claim 1, wherein:
the RACH response indicates one or more CLI measurement resources and one or more CLI reporting resources, and
the one or more processors are further configured to:
generate second CLI measurement data based on CLI measured by the UE in the one or more CLI measurement resources; and
transmit, to the network entity, the second CLI measurement data using the one or more CLI reporting resources.

6. The UE of claim 1, wherein:
the one or more processors are further configured to receive CLI configuration information that specifies, for each SSB beam of the plurality of SSB beams, one or more RACH occasions for the SSB beam,
to generate the CLI measurement data, the one or more processors are configured to generate the CLI measurement data for each of the SSB beams based on CLI measured by the UE on each of the SSB beams, and
the one or more processors are further configured to, for each of the SSB beams, transmit, to the network entity, the CLI measurement data for the SSB beam during the one or more RACH occasions for the SSB beam.

7. The UE of claim 1, wherein:
the one or more processors are further configured to receive, from the network entity, CLI configuration information, the CLI configuration information configuring the UE to measure CLI on CLI measurement resources, wherein the CLI measurement resources are mapped to the one or more SSBs,
to receive the one or more SSBs, the one or more processors are configured to receive the one or more SSBs using a spatial filter, and
to generate the CLI measurement data, the one or more processors are configured to, before sending the random-access request, generate the CLI measurement data based on CLI measured by the UE, while using the spatial filter, in the CLI measurement resources.

8. The UE of claim 1, wherein:
the one or more processors are further configured to receive CLI configuration information from the network entity, the CLI configuration information indicating CLI measurement resources in which to measure CLI,
to receive the one or more SSBs, the one or more processors are configured to receive the one or more SSBs using a spatial filter,
to generate the CLI measurement data, the one or more processors are configured to generate the CLI measurement data based on CLI measured by the UE, while using the spatial filter, in the CLI measurement resources, and
the random-access request or a message sent by the UE to the network entity after the random-access request includes the CLI measurement data.

9. The UE of claim 1, wherein to obtain the CLI measurement data, the one or more processors are configured to:
measure CLI only within downlink (DL)-usable physical resource blocks (PRBs) within a DL bandwidth part (BWP),
measure the CLI only within an uplink (UL)-usable PRBs within the DL BWP, or
measure the CLI in the DL-usable PRBs and the UL-usable PRBs.

10. The UE of claim 1, wherein the one or more processors are further configured to:
transmit, to the network entity, UE capability information during an initial access process, where the UE capability information includes one or more of:
data indicating whether the UE is configured to support CLI measurement and reporting as part of RACH messaging,
a maximum CLI measurement resources rate that the UE is currently configured to buffer, wherein the maximum CLI measurement resources rate is one of: a maximum number of CLI measurement resources per slot, a maximum number of CLI measurement resources per component carrier (CC), or a maximum number of CLI measurement resources across CC,
a maximum CLI resources rate that the UE is able to be configured to buffer, or
CLI report granularity information.

11. A method of wireless communication, comprising:
receiving, by a User Equipment (UE), one or more Synchronization Signal Blocks (SSBs) broadcast by a network entity;
generating, by the UE, cross-link interference (CLI) measurement data using resources corresponding to the one or more SSBs;
selecting, by the UE, based on the CLI measurement data, an SSB beam from among a plurality of SSB beams;
determining, by the UE, based on the one or more SSBs, a Random-Access Channel (RACH) occasion associated with the SSB beam; and
transmitting, by the UE to the network entity via a PRACH mapped to the SSB beam, a random-access request at the RACH occasion; and
receiving, by the UE from the network entity via the SSB beam, a RACH response in response to the random-access request.

12. The method of claim 11, further comprising:
receiving, by the UE, CLI configuration information from the network entity, wherein the CLI configuration information configures the UE to measure the CLI on one or more CLI measurement resources, wherein the one or more CLI measurement resources are mapped to the one or more SSBs.

13. The method of claim 12, wherein the one or more CLI measurement resources include periodic measurement resources configured on sub-band full duplex (SBFD) symbols and quasi-collocated with the SSB beams.

14. The method of claim 12, wherein:
the receiving the CLI configuration information comprises receiving the CLI configuration information in a message broadcast by the network entity, or
the receiving the CLI configuration information comprises receiving the CLI configuration information as part of an on-demand system information block (SIB) requested by the UE.

15. The method of claim 11, wherein:
the RACH response indicates one or more CLI measurement resources and one or more CLI reporting resources, and
the method further comprises:
generating, by the UE, second CLI measurement data based on CLI measured by the UE in the one or more CLI measurement resources; and
transmitting, by the UE to the network entity, the second CLI measurement data using the one or more CLI reporting resources.

16. The method of claim 11, wherein:
the method further comprises receiving CLI configuration information that specifies, for each SSB beam of the plurality of SSB beams, one or more RACH occasions for the SSB beam;
generating the CLI measurement data comprises generating the CLI measurement data for each of the SSB beams based on CLI measured by the UE on each of the SSB beams, and
the method further comprises, for each of the SSB beams, transmitting, by the UE to the network entity, the CLI measurement data for the SSB beam during the one or more RACH occasions for the SSB beam.

17. The method of claim 11, wherein:
the method further comprises receiving, by the UE from the network entity, CLI configuration information, the CLI configuration information configuring the UE to measure CLI on CLI measurement resources, wherein the CLI measurement resources are mapped to the one or more SSBs,
receiving the one or more SSBs comprises receiving, by the UE, the one or more SSBs using a spatial filter, and
generating the CLI measurement data comprises, before sending the random-access request, generating, by the UE, the CLI measurement data based on CLI measured by the UE, while using the spatial filter, in the CLI measurement resources.

18. The method of claim 11, wherein:
the method further comprises receiving, by the UE, CLI configuration information from the network entity, the CLI configuration information indicating CLI measurement resources in which to measure CLI,
receiving the one or more SSBs comprises receiving, by the UE, the one or more SSBs using a spatial filter,
generating the CLI measurement data comprises generating, by the UE, the CLI measurement data based on CLI measured by the UE, while using the spatial filter, in the CLI measurement resources, and
the random-access request or a message sent by the UE to the network entity after the random-access request includes the CLI measurement data.

19. The method of claim 11, wherein obtaining the CLI measurement data comprises one of:
measuring, by the UE, CLI only within downlink (DL)-usable physical resource blocks (PRBs) within a DL bandwidth part (BWP),
measuring, by the UE, the CLI only within an uplink (UL)-usable PRBs within the DL BWP, or
measuring, by the UE, the CLI in the DL-usable PRBs and the UL-usable PRBs.

20. An apparatus for wireless communication, comprising means for:
receiving one or more Synchronization Signal Blocks (SSBs) broadcast by a network entity;
generating cross-link interference (CLI) measurement data using resources corresponding to the one or more SSBs;
selecting, based on the CLI measurement data, an SSB beam from among a plurality of SSB beams;
determining, based on the one or more SSBs, a Random-Access Channel (RACH) occasion associated with the SSB beam; and
transmitting, to the network entity via a PRACH mapped to the SSB beam, a random-access request at the RACH occasion; and
receiving, from the network entity via the SSB beam, a RACH response in response to the random-access request.
